(19) United States
(12) Patent Application Publication
(10) Pub. No.: US 2008/0219742 A1
(43) Pub. Date: Sep. 11, 2008

(54) TAPE DRIVE

(76) Inventors: Martin McNestry, Derbyshire (GB); Keith Buxton, Nottingham (GB)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 12/043,213

(22) Filed: Mar. 6, 2008

Related U.S. Application Data
(60) Provisional application No. 60/894,516, filed on Mar. 13, 2007.

(30) Foreign Application Priority Data
Mar. 7, 2007 (GB) 0704370.6

(51) Int. Cl. B41J 33/02

(52) U.S. Cl. 400/234

(57) ABSTRACT

A tape drive comprising two tape spool supports on which spools of tape may be mounted, at least one spool being drivable by a respective motor, a controller for controlling the energization of said at least one motor such that the tape may be transported in at least one direction between spools mounted on the spool supports, and a sensor configured to obtain signals indicative of electromagnetic radiation reflected from the tape, wherein means are provided to process two signals obtained by said sensor and to generate an output signal indicative of movement of said tape based on said signals.

### CROSS-REFERENCE TO RELATED APPLICATIONS

This application claims priority to and is based on United Kingdom Application No. 0704370.6 filed Mar. 7, 2007, and incorporated herein by reference in its entirety.

In addition, this application claims priority to and is based on U.S. Provisional Application No. 60/894,516 filed Mar. 13, 2007, and incorporated herein by reference in its entirety.

### BACKGROUND OF THE INVENTION

The present invention relates to a tape drive. Such a tape drive may form part of printing apparatus. In particular, such a tape drive may be used in transfer printers, that is, printers which make use of carrier-supported inks.

In transfer printers, a tape which is normally referred to as a printer tape and carries ink on one side is presented within a printer such that a printhead can contact the other side of the tape to cause the ink to be transferred from the tape on to a target substrate of, for example, paper or a flexible film. Such printers are used in many applications. Industrial printing applications include thermal transfer label printers and thermal transfer coders which print directly on to a substrate such as packaging materials manufactured from flexible film or card.

Ink tape is normally delivered to the end user in the form of a roll wound onto a core. The end user pushes the core on to a tape spool, pulls a free end of the roll to release a length of tape, and then engages the end of the tape with a further spool. The spools may be mounted on a cassette, which can be readily mounted on a printing machine. The printing machine includes a transport means for driving the spools, so as to unwind tape from one spool and to take up tape on the other spool. The printing apparatus transports tape between the two spools along a predetermined path past the printhead.

Known printers of the above type rely upon a wide range of different approaches to the problem of how to drive the tape spools. Some rely upon stepper motors operating in a position control mode to pay out or take-up a predetermined quantity of tape. Other known printers rely on DC motors operating in a torque mode to provide tension in the tape and to directly or indirectly drive the spools. Some known arrangements drive only the spool on to which tape is taken up (the take-up spool) and rely upon some form of “slipping clutch” arrangement on the spool from which tape is drawn (the supply spool) to provide a resistive drag force so as to ensure that the tape is maintained in tension during the printing and tape winding processes and to prevent tape overrun when the tape is brought to rest. It will be appreciated that maintaining adequate tension is an essential requirement for the proper functioning of the printer.

Alternative forms of known printer tape drives drive both the take-up spool and the supply spool. A supply spool motor may be arranged to apply a predetermined drag to the tape, by being driven in the reverse direction to the direction of tape transport. In such an arrangement (referred to herein as “pull-drag”), the motor connected to the take-up spool is arranged to apply a greater force to the tape than the motor connected to the supply spool such that the supply spool motor is overpowered and the supply spool thus rotates in the direction of tape transport. The supply spool drag motor keeps the tape tensioned in normal operation.

In a further alternative arrangement a supply spool motor may be driven in the direction of tape transport such that it contributes to driving the tape from the supply spool to the take-up spool. Such an arrangement is referred to herein as “push-pull”. The take-up motor pulls the tape onto the take-up spool as tape is unwound by the supply spool motor such that tape tension is maintained. Such a push-pull arrangement is described in our earlier UK Patent No. GB 2,369,602, which discloses the use of a pair of stepper motors to drive the supply spool and the take-up spool. In GB 2,369,602 a controller is arranged to control the energization of the motors such that the tape may be transported in both directions between spools of tape. The tension in the tape being transported between spools is monitored and the motors are controlled to energise both motors to drive the spools of tape in the direction of tape transport.

As a printer gradually uses a roll of tape, the outer diameter of the supply spool decreases and the outer diameter of the take-up spool increases. In slipping clutch arrangements, which offer an essentially constant resistive torque, the tape tension will vary in proportion to the diameter of the spools. Given that it is desirable to use large supply spools so as to minimise the number of times that a tape roll has to be replenished, this is a serious problem particularly in high-speed machines where rapid tape transport is essential. For tape drives that use both a take-up motor and a supply spool motor, the variation in spool diameters can make it difficult to determine the correct drive signal to be supplied to each motor such that tape tension is maintained, and/or that tape is unwound or rewound at the correct rate.

Given these constraints, known printer designs offer a compromise in performance by way of limiting the rate of acceleration, the rate of deceleration, and the maximum speed capability of the tape transport system. Overall printer performance has, as a result, been compromised in some cases.

Known tape drive systems generally operate in one of two manners, that is either continuous printing or intermittent printing. In both modes of operation, the apparatus performs a regularly repeated series of printing cycles, each cycle including a printing phase during which ink is being transferred to a substrate, and a further non-printing phase during which the apparatus is prepared for the printing phase of the next cycle.

In continuous printing, during the printing phase a stationary printhead is brought into contact with a printer tape the other side of which is in contact with a substrate on to which an image is to be printed. The term “stationary” is used in the context of continuous printing to indicate that although the printhead will be moved into and out of contact with the tape, it will not move relative to the tape path in the direction in which tape is advanced along that path. During printing, both the substrate and tape are transported past the printhead, generally but not necessarily at the same speed.

Generally only relatively small lengths of the substrate which is transported past the printhead are to be printed upon, and therefore to avoid gross wastage of tape it is necessary to reverse the direction of travel of the tape between printing operations. Thus in a typical printing process in which the substrate is travelling at a constant velocity, the printhead is extended into contact with the tape only when the printhead is adjacent to regions of the substrate to be printed. Immediately before extension of the printhead, the tape must be accelerated up to, for example, the speed of travel of the substrate. The tape speed must then be maintained at the constant speed of the substrate during the printing phase and, after the printing phase has been completed, the tape must be decelerated and then driven in the reverse direction so that the used region of the tape is on the upstream side of the printhead.

As the next region of the substrate to be printed approaches, the tape must then be accelerated back up to the normal printing speed and the tape must be positioned so that an unused portion of the tape close to the previously used region of the tape is located between the printhead and the substrate when the printhead is advanced to the printing position. Thus very rapid acceleration and deceleration of the tape in both directions is required, and the tape drive system must be capable of accurately locating the tape so as to avoid a printing operation being conducted when a previously used portion of the tape is interposed between the printhead and the substrate.

In intermittent printing, a substrate is advanced past a printhead in a stepwise manner such that during the printing phase of each cycle the substrate and generally but not necessarily the tape, are stationary. Relative movement between the substrate, tape and printhead are achieved by displacing the printhead relative to the substrate and tape. Between the printing phase of successive cycles, the substrate is advanced so as to present the next region to be printed beneath the printhead, and the tape is advanced so that an unused section of tape is located between the printhead and the substrate. Once again rapid and accurate transport of the tape is necessary to ensure that unused tape is always located between the substrate and printhead at a time that the printhead is advanced to conduct a printing operation.

The requirements of high speed transfer printers in terms of tape acceleration, deceleration, speed and positional accuracy are such that many known drive mechanisms have difficulty delivering acceptable performance with a high degree of reliability. Similar constraints also apply in applications other than high-speed printers, for instance drives used in labelling machines, which are adapted to apply labels detached from a label web. Tape drives in accordance with embodiments of the present invention are suitable for use in labelling machines in which labels are detached from a continuous label web which is transported between a supply spool and a take-up spool.

### BRIEF DESCRIPTION OF THE INVENTION

It is an object of embodiments of the present invention to obviate or mitigate one or more of the problems associated with the prior art, whether identified herein or elsewhere. It is a further object of embodiments of the present invention to provide a tape drive which can be used to deliver printer tape in a manner which is capable of meeting the requirements of high speed production lines, although the tape drive of the present invention may of course be used in any other application where similar high performance requirements are demanded.

According to the present invention, there is provided a tape drive, two tape spool supports on which spools of tape may be mounted, at least one spool being drivable by a respective motor, a controller for controlling the energization of said motor such that the tape may be transported in at least one direction between spools mounted on the spool supports, and a sensor configured to obtain signals indicative of electromagnetic radiation reflected from a moving tape drive element, wherein means are provided to process two signals obtained by said sensor and to generate an output signal indicative of movement of said tape drive element based on said signals.

The present inventors have surprisingly discovered that processing a plurality of signals indicative of reflected electromagnetic radiation provides an effective way of monitoring displacement of a tape drive element.

The tape drive may comprise two motors. Each spool may be drivable by a respective one of said motors.

The sensor may be an optical sensor arranged to capture light reflected from the moving tape drive element. In such a case the signals may take the form of images. The tape drive may further comprise an illumination source arranged to illuminate at least a portion of the moving tape drive element. The sensor may comprise the illumination source, and a charge-coupled device to capture said reflected light. The sensor may comprise said means to process said two signals, and may be adapted to provide said output signal to said controller. The sensor can take any suitable form. For example the sensor can take the form of a sensor commonly used in an optical computer mouse.

The means for processing two signals obtained by said sensor and generating said output signal may comprise identification means for identifying portions of each of the two signals caused by electromagnetic radiation reflected from a common part of the moving tape drive element. The output signal may be generated based upon said portions of said two signals.

The moving tape drive element may be the tape itself, and the sensor may be located proximate to a portion of the tape path between the spools.

The moving tape drive element may comprise a rotating tape drive element, the position signal being indicative of rotational movement of the rotating tape drive element. The rotating tape drive element may comprise a rotating disc arranged such that rotation of the disc is indicative of rotation of one of said spools of tape. The rotating disc may be coupled to said spool.

The controller may be arranged to use the output signal to provide a control signal to drive at least one of said motors. The controller may be operative to use the output signal to provide control signals to both of said motors.

The motors can take any suitable form. At least one of said motors may be a torque-controlled motor. The controller may be adapted to provide a control signal to the torque-controlled motor based upon said output signal such that the output angular position of the torque-controlled motor is controlled At least one of the motors is a position-controlled motor. For example an open-loop position-controlled motor such as a stepper motor.

The controller may be arranged to control the motors to transport tape in both directions between the spools. The controller may be operative to monitor tension in a tape being transported between the spools. The controller may be operative to control the motors to maintain tape tension within predetermined limits.

A tape drive in accordance with certain embodiments of the present invention relies upon both the motors that drive the two tape spools to drive the tape during tape transport. Thus the two motors operate in push-pull mode. This makes it possible to achieve very high rates of acceleration and deceleration. Tension in the tape being transported is determined by control of the drive motors and therefore is not dependent upon any components that have to contact the tape between the take-up and supply spools. Thus a very simple overall mechanical assembly can be achieved. Given that both motors contribute to tape transport, relatively small and therefore inexpensive and compact motors can be used.

A tape drive in accordance with certain other embodiments of the present invention operates in a pull-drag mode in which the motor attached to the spool currently taking up tape drives the spool in the direction of tape transport, whereas the motor coupled to the other spool is driven in a reverse direction in order to tension the tape. In accordance with yet other embodiments of the present invention the tape drive motors may be arranged to operate in a push-pull mode for at least part of a printing cycle and a pull-drag mode for at least another part of the printing cycle.

The actual rotational direction of each spool will depend on the sense in which the tape is wound on each spool. If both spools are wound in the same sense then both spools will rotate in the same rotational direction to transport the tape. If the spools are wound in the opposite sense to one another, then the spools will rotate in opposite rotational directions to transport the tape. In any configuration, both spools rotate in the direction of tape transport. However, according to the operating mode of the supply spool motor, the direction in which it is driven may also be in the same direction as the supply spool (when the motor is assisting in driving the tape, by pushing the tape off the spool) or the supply spool motor may be driven in the opposite direction to that of the supply spool (when the motor is providing drag to the tape in order to tension the tape).

It is preferred that each spool support is coupled to a respective motor by means of a drive coupling providing at least one fixed transmission ratio. Preferably, the ratio of angular velocities of each motor and its respective spool support is fixed. Such an arrangement requires that control of a motor to cause a desired linear tape movement from or to a respective spool takes into account the circumference of that spool.

The drive coupling may comprise a drive belt. Alternatively, as each spool support has a respective first axis of rotation and each motor has a shaft with a respective second axis of rotation, the respective first and second axes may be coaxial. Respective drive couplings may interconnect a respective spool shaft to a respective motor shaft.

The tape drive may be incorporated in a transfer printer for transferring ink from a printer tape to a substrate, which is transported along a predetermined path adjacent to the printer. The tape drive may act as a printer tape drive mechanism for transporting ink ribbon between first and second tape spools, and the printer further comprising a printhead arranged to contact one side of the ribbon to press an opposite side of the ribbon into contact with a substrate on the predetermined path. There may also be provided a printhead drive mechanism for transporting the printhead along a track extending generally parallel to the predetermined substrate transport path (when the printer is operating in an intermittent printing mode) and for displacing the printhead into and out of contact with the tape. A controller may control the printer ink ribbon and printhead drive mechanisms, and the controller may be selectively programmable either to cause the ink ribbon to be transported relative to the predetermined substrate transport path with the printhead stationary and displaced into contact with the ink ribbon during printing, or to cause the printhead to be transported relative to the ink ribbon and the predetermined substrate transport path and to be displaced into contact with the ink ribbon during printing.

The drive mechanism may be bi-directional such that tape may be transported from a first spool to a second spool and from the second spool to the first. Typically, unused tape is provided in a roll of tape mounted on the supply spool. Used tape is taken up on a roll mounted on the take-up spool. However, as described above, in order to prevent gross ribbon wastage, after a printing operation the tape can be reversed such that unused portions of the tape may be used before being wound onto the take-up spool.

### BRIEF DESCRIPTION OF THE DRAWINGS

Embodiments of the present invention will now be described, by way of example, with reference to the accompanying drawings in which:

FIG. 1 is a schematic illustration of a printer tape drive system in accordance with an embodiment of the present invention;

FIGS. 2A and 2B are illustrations showing how a sensor in the tape drive of FIG. 1 monitors tape movement;

FIG. 3 is an illustration showing how a sensor monitors movement of a rotating element in a tape drive; and

FIG. 4 is a schematic illustration showing the controller of FIG. 1 in further detail.

### DETAILED DESCRIPTION OF THE INVENTION

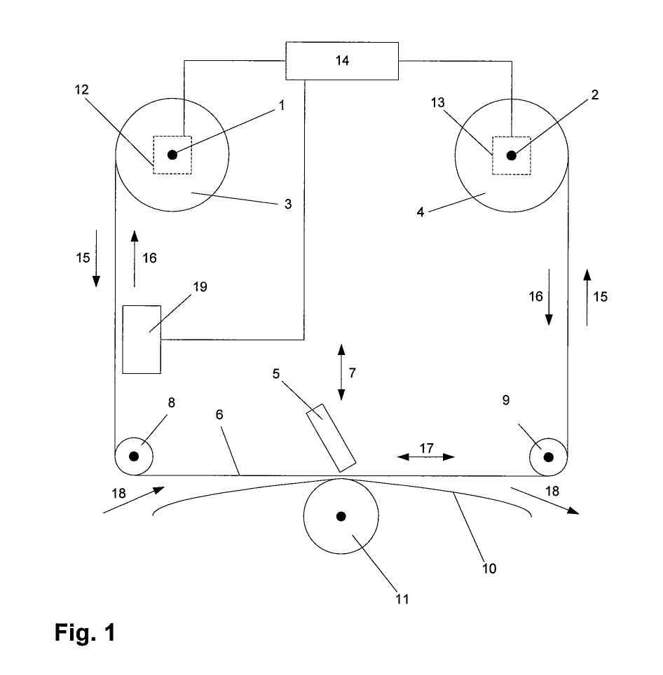

Referring to FIG. 1, this schematically illustrates a tape drive in accordance with the present invention suitable for use in a thermal transfer printer. First and second shafts 1, 2 support a supply spool 3 and a take-up spool 4 respectively. The supply spool 3 is initially wound with a roll of unused tape, and the take-up spool 4 initially does not carry any tape. As tape is used, used portions of the tape are transported from the supply spool 3 to the take-up spool 4. A displaceable printhead 5 is provided, displaceable relative to tape 6 in at least a first direction indicated by arrow 7. Tape 6 extends from the supply spool 3 around rollers 8, 9 to the take-up spool 4. The path followed by the tape 6 between the rollers 8 and 9 passes in front of the printhead 5. A substrate 10 upon which print is to be deposited is brought into contact with the tape 6 between rollers 8 and 9, the tape 6 being interposed between the printhead 5 and the substrate 10. The substrate 10 may be brought into contact with the tape 6 against a platen roller 11.

The supply shaft 1 is driven by a supply motor 12 and the take-up shaft 2 is driven by a take-up motor 13. The supply and take-up motors 12, 13 are illustrated in dashed outline, indicating that they are positioned behind the supply and take-up spools 3, 4. It will however be appreciated that in alternative embodiments of the invention, the spools are not directly driven by the motors. Instead the motor shafts may be operably connected to the respective spools by a belt drive or other similar drive mechanism. In either case, it can be seen that there is a fixed transmission ratio between a motor and its respective spool support.

A controller 14 controls the operation of motors 12, 13 as described in greater detail below. The supply and take-up motors 12, 13 are capable of driving the tape 6 in both directions. Tape movement may be defined as being in the print direction if the tape is moving from the supply spool 3 to the take-up spool 4, as indicated by arrows 15. When tape is moving from the take-up spool 4 to the supply spool 3, the tape may be considered to be moving in the tape reverse direction, as indicated by arrows 16.

When the printer is operating in continuous mode the printhead 5 will be moved into contact with the tape 6 when the tape 6 is moving in the print direction 15. Ink is transferred from the tape 6 to the substrate 10 by the action of the printhead 5. Tape movement may be reversed such that unused portions of the tape 6 are positioned adjacent to the printhead 5 before a subsequent printing operation is commenced.

In the configuration illustrated in FIG. 1, the spools 3, 4 are wound in the same sense as one another and thus rotate in the same rotational direction to transport the tape. Alternatively, the spools 3, 4 may be wound in the opposite sense to one another, and thus must rotate in opposite directions to transport the tape.

As described above, the printer schematically illustrated in FIG. 1 can be used for both continuous and intermittent printing applications. The controller 14 is selectively programmable to select either continuous or intermittent operation. In continuous applications, the substrate 10 will be moving continuously. During a printing cycle, the printhead 5 will be stationary but the tape will move so as to present fresh tape to the printhead 5 as the cycle progresses. In contrast, in intermittent applications, the substrate 10 is stationary during each printing cycle, the necessary relative movement between the substrate 10 and the printhead 5 being achieved by moving the printhead 5 parallel to the tape 6 and substrate 10 in the direction of arrow 17 during the printing cycle. In such a case, the roller 11 is replaced with a flat print platen (not shown) against which the printhead 5 presses the ribbon 6 and substrate 10. In both applications, it is necessary to be able to rapidly advance and return the tape 6 between printing cycles so as to present fresh tape to the printhead and to minimise tape wastage. Given the speed at which printing machines operate, and that fresh tape 6 should be present between the printhead 5 and substrate 10 during every printing cycle, it is necessary to be able to accelerate the tape 6 in both directions at a high rate and to accurately position the tape relative to the printhead. In the arrangement shown in FIG. 1 it is assumed that the substrate 10 will move only to the right as indicated by arrows 18. However, the apparatus can be readily adapted to print on a substrate travelling to the left (that is, in the opposite direction) in FIG. 1.

The printer shown in FIG. 1 further comprises a sensor 19 which is adapted to sense displacement of the tape 6 and provide a signal indicative of tape displacement to the controller 14. The sensor 19 can take any suitable form. For example, the sensor 19 may take the form of an optical sensor. Such an optical sensor may take the form of a charge coupled device (CCD). In general terms the sensor captures two images of the tape as it moves from the supply spool 3 to the take-up spool 4. By comparing the captured images, tape displacement can be determined as described below. There are a wide range of commercially available CCDs. Suitable CCDs are commonly used within an optical computer mouse, and thus may be referred to as optical mouse sensors.

An example of a suitable commercially available optical mouse sensor that may be used within a tape drive as the sensor 19 is the ADNS-3060, which is manufactured by Agilent Technologies. It will be appreciated that other similar sensors could also be used. The ADNS-3060 is an optical sensor that is typically used to detect high speed motion, for instance speeds of up to approximately 1 ms⁻¹, and accelerations of up to approximately 150 ms⁻². Such a mouse sensor operates by recording a series of images of the surface over which it is passed, typically up to 6400 images per second. The resolution of each image is up to 800 counts per inch (cpi). In alternative embodiments of the invention, the ADNS-3080 sensor is used, again manufactured by Agilent Technologies. This sensor provides a resolution of up to 1600 cpi. It is preferred that the sensor is able to allow control of the tape drive substantially in realtime. Accordingly, sensor response speed is of considerable importance. Indeed, in a single tape movement operation in a printing apparatus a plurality of sensor measurements may be provided and processed.

The present inventors have realised that such an optical mouse sensor may be used to measure linear displacement of a tape. The available resolution of the ADNS-3060 is sufficient to detect surface flaws in a portion of the tape, such that displacement can be detected as described below.

The ADNS-3060 measures changes in position by optically acquiring sequential surface images and mathematically determining the direction and magnitude of movement between consecutive frames. By recording a plurality of frames over a known period of time, the change in position, speed and acceleration of the tape can be calculated.

The ADNS-3060 drives a light source in the form of an LED together with a CCD for capturing images at a predetermined rate. An internal microprocessor is adapted to calculate relative motion between frames in first and second orthogonal directions, and provide the calculated relative motion at a serial interface. Data provided at the serial interface is provided to the controller 14.

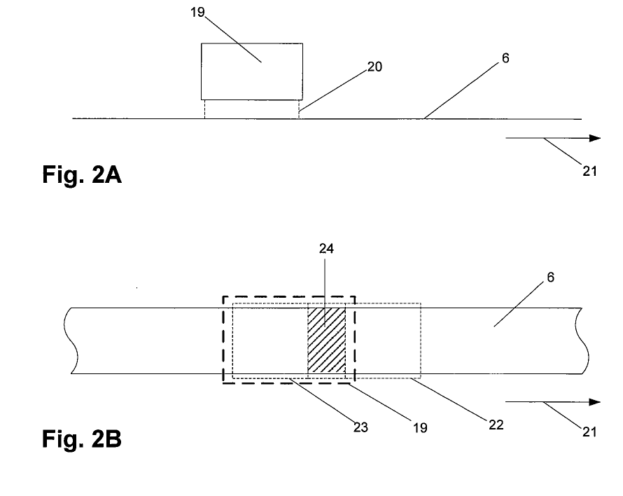

Referring now to FIG. 2A, this schematically illustrates in side view a portion of the tape 6 and the sensor 19 arranged to capture a series of images of the surface of the tape 6 at predetermined intervals. The field of view of the optical sensor 19 is indicated by dashed lines 20. For the purpose of explaining the operation of the sensor 19, the tape 6 is considered only to be moving in a single direction, indicated by an arrow 21. It will however be appreciated that the tape may be travelling in either direction, and the optical sensor is able to detect motion in both directions.

FIG. 2B is a plan view of the same optical sensor arrangement of FIG. 2A. The optical sensor 19 is illustrated in dashed outline so as not to obscure the representation of the field of view of the sensor 19. FIG. 2B further illustrates a first image 22 captured by the sensor 19. The tape 6 has moved to the right (in the direction of arrow 21) since the first image 22 was captured. After a predetermined time interval, the tape 6 is now positioned relative to the optical sensor 19 as illustrated and a second image 23 is captured, corresponding to the current field of view of the sensor 19.

It can be seen that the first image 22 and the second image 23 include a common part of the tape 6 indicated by the hatched area 24. By comparison of variations in the surface texture of the tape 6 captured in the two images 22, 23 the area of overlap 24 between the two images can be detected. The position of the area of overlap 24 in each of the images 22, 23 can then be determined, allowing the amount by which the tape 6 has moved between the first image 22 and the second image 23 can be determined. It will be apparent that as long as consecutive images are recorded sufficiently frequently, such that they contain an area of overlap even when the tape 6 is travelling at its maximum velocity, then relative movement of the tape 6 between consecutive images will always be measurable. From knowledge of an elapsed time between capture of the two images, the velocity of the tape can be determined.

In the above described embodiment, the sensor 19 is positioned proximate a portion of the tape transport path so as to detect linear tape movement. In an alternative embodiment of the invention, an optical sensor of the type described is used to monitor rotation of one or both of the supply spool motor 12 and the take up motor 13.

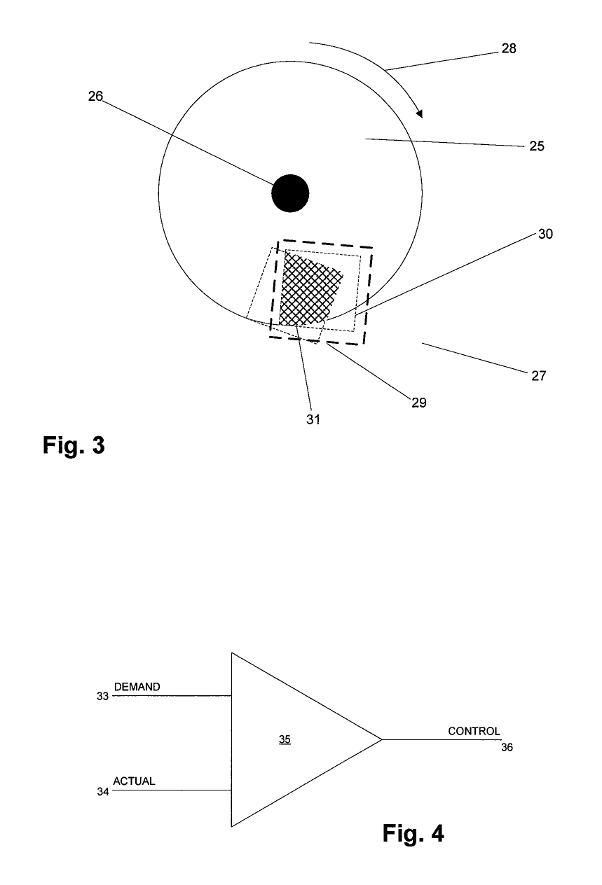

Referring now to FIG. 3, this schematically illustrates a rotating disc 25, which rotates about an axis 26. The disc 25 may be connected directly to a spool of tape such that measuring angular movement of the disc provides a direct measurement of angular movement of the spool.

In one embodiment of the present invention, a spool motor may be provided with a double ended shaft, one end of which supports a spool of tape, and the other end of which extends back though a printed circuit board and is coupled to a disc on the opposite side of the printed circuit board to the spool of tape. An optical sensor 27 such as is described above may be directly mounted upon the printed circuit board so as to be able to directly capture images of the rotating disc 25. The optical sensor 27 is shown in dashed outline so as to not obscure details of the captured images.

The optical sensor 27 is arranged to capture a series of images of a portion of the surface of the rotating disc 25. It will be appreciated that there is no requirement that the optical sensor 27 is able to capture such a large portion of the disc 25. The only requirement is that the field of view and the frame rate of the sensor are sufficiently great that a common portion of the disc is in view for consecutive images, in a similar way to as described above with reference to monitoring movement of tape. In order to simplify the processing of the image data, it may be desirable to arrange the sensor 27 towards an outer edge of the disc 25, and arrange for the field of view to be small relative to the size of the disc, such that relative movement of two consecutive images is predominantly in a single linear direction (orthogonal to the radius of the disc).

For the purpose of explaining the operation of the arrangement of FIG. 3, the disc 25 will be considered only to be rotating in a single direction, indicated by arrow 28. It will however be appreciated that the disc may be rotating in either direction, and the optical sensor will be able to detect a change in angular position in both directions.

FIG. 3 further illustrates a first image 29 captured by the optical sensor. The disc 25 has rotated clockwise (in the direction of arrow 28) since the first image 29 was captured. After the predetermined time interval the disc 25 is now positioned relative to the optical sensor 27 as illustrated and a second image 30, corresponding to the current field of view of the sensor 27 is captured.

It can be seen that the first and second images overlap. That is, the images both include a common portion of the disc indicated by the hatched area 31. By comparison of variations in the surface texture of the disc 25 captured in the two images 29, 30 the area of overlap 31 between the two images can be determined, and consequently the amount by which the disc 25 has rotated between capture of the first and second images can be determined. This allows a change in angular position to be determined. If the time between capture of the two images is known, the angular velocity of the disc 25 can be determined.

In a first described embodiment of the invention, one of the motors 12, 13 is a torque-controlled motor. The torque motor is controlled using a control signal which is generated with reference to a signal received from the sensor 19 shown in FIG. 1, or the sensor 27 shown in FIG. 3, as is now described. A torque-controlled motor is a motor that is controlled by a demanded output torque. An example of a torque-controlled motor is a DC motor without encoder feedback, or a DC motor having an encoder, but in which the encoder signal is temporarily or permanently not used. Alternatively, coupling a stepper motor with an encoder and using the encoder output signal to generate a commutation signal that in turn drives the motor can provide a torque-controlled stepper motor. Varying the current that may be drawn by the motor can vary the torque provided by a torque-controlled motor of either sort.

Part of the controller is shown in further detail in FIG. 4. The controller is configured to process two signals, a first indicating a demand position and a second indicating an actual position. The actual position can take the form of an actual tape position provided by the sensor 19 of FIG. 1, or can alternatively take the form of an actual rotational position of the disc 25 provided by the sensor 27 of FIG. 3. In either case, signals indicative of a demand position 33 and an actual position 34 are input to a differential amplifier 35, which outputs a control signal 36 which is provided to the torque-controlled motor.

The differential amplifier 35 determines the output control signal 36 by determining a difference between the demand position 33 the actual position 34, and using the determined difference to generate the output control signal 36.

The feedback signal from the sensor 19 or the sensor 27 is thus used by the controller to adjust the drive signal to a torque-controlled motor, such that the torque controlled motor is provided with a control signal meaning that it is driven until the demanded tape displacement has been achieved. This effectively means that the torque-controlled motor functions in a closed loop manner providing a position-controlled motor.

A position-controlled motor comprises a motor controlled by a demanded output position. That is, the output position may be varied on demand, or the output rotational velocity may be varied by control of the speed at which the demanded output rotary position changes. An example of a position-controlled motor is a stepper motor, which is an open loop position-controlled motor.

In an alternative embodiment of the present invention, the controller 14 uses signals indicative of demanded and actual displacement to control an open loop position-controlled motor, such as a stepper motor, thus operating the open loop position-controlled motor as a closed loop position-controlled motor.

In general terms, the tape drive shown in FIG. 1 can be operated using any combination of torque-controlled and position-controlled motors. For example, the take up motor 13 may be a torque-controlled motor. In such a case when tape is moving in the print direction 15, the torque-controlled take up motor 13 is energised in the direction of tape transport so as to cause the tape to move. However, when tape is moved in the tape-reverse direction 16, the torque-controlled take up motor 13 is energised so as to oppose tape movement, and thereby apply tension to the tape. Therefore when travelling in the tape-reverse direction 16 the supply motor 12 (which is coupled to the spool 3 on which tape is being wound) must apply a force to pull tape onto the spool 3 and to overcome the force applied by the torque-controlled motor 13. In such a case the supply motor 12 can be a position-controlled or torque-controlled motor. Where the supply motor 12 is a position-controlled motor, when the tape is moving in the print direction 15 the position-controlled motor is energised in the direction of tape transport.

It can thus be seen that a tape drive in accordance with embodiments of the present invention may be operated in any required mode, for instance push-pull or pull-drag. The sensor 19 can be used to control either the supply motor 12, the take-up motor 13, or both. Furthermore, the sensor 19 may be used to separately control each motor during different portions of a printing cycle. For instance, the tape drive may comprise two torque controlled motors. The linear position encoder may be used to provide a tape position feedback signal to whichever motor is driving a spool currently taking-up tape (such that the tape drive operates in pull-drag mode in both the print direction and the tape reverse direction). Alternatively, the sensor 19 may be used to provide a feedback signal to whichever motor is driving a spool currently supplying tape (such that the tape drive operates in push-pull mode in both the print direction and the tape reverse direction). It will be appreciated that the sensor 19 can be used to drive a wide variety of motor types in any convenient way.

In some embodiments of the invention, the sensor 27 shown in FIG. 3 is used instead of or as well as the sensor 19. In either case signals received from the sensor 27 are used by the controller to influence the way in which at least one of the motors 12, 13 is controlled.

For a tape drive comprising two torque-controlled motors, only one of which is controlled using the linear position sensor signal for position control, tension within the tape may be set by torque control of the other motor.

In general terms, the tape drive described with reference to FIG. 1 is configured to carry out a plurality of tape movement operations, each operation being associated with a particular print operation. Each tape movement operation will have one or more demanded tape displacements which are provided to the controller 14. Where more than one tape displacement is provided to the controller 14, by providing suitable displacements at predetermined time intervals, a desired acceleration profile can be achieved. Thus, each tape displacement provided to the controller 14 is preferably determined with reference to predefined data defining tape movement requirements.

In accordance with a further embodiment of the present invention, more than one linear position sensor is used, either for redundancy or to separately control each motor. That is, the controller may receive two signals indicative of actual tape displacement, each signal being received from a sensor similar to the sensor 19 shown in FIG. 1 and described above. These signals can either be used to generate two respective control signals, one for each of the supply motor 12 and the take-up motor 13 or can alternatively be used in combination for control of one or both of the motors.

If the rotation of a spool of tape is monitored to determine an angle of rotation through which the spool has turned, then by knowing the amount of tape that is wound or unwound from the spool, using the sensor 19, the current diameter of the spool can be calculated.

However, if the supply motor 12 is a position-controlled motor, by knowing a linear displacement (provided by the sensor 19) and knowing a rotation of the supply motor 12 providing that displacement, the diameter of the supply spool 3 can be determined. Although it is sometimes preferred to determine spool diameters, it should be noted that in a tape drive employing the sensor 19, spool diameter determination is not essential.

In accordance with certain embodiments of the present invention tape tension is monitored in order to provide a feedback signal allowing the drive signal provided to one or both motors to be varied in order to control the actual tension in the tape. This is different to and more accurate than only varying the drive signal in accordance with a demanded tape tension, which may differ from the actual tape tension due to factors external to the motors, for instance the tape stretching over time.

Where appropriate, any suitable method of measuring the tension of a tape may be used, including directly monitoring the tension through the use of a component that contacts the tape and indirect tension monitoring. Direct tension monitoring includes, for example, a resiliently biased roller or dancing arm that is in contact with the tape, arranged such that a change in tape tension causes the roller or dancing arm to move position, the change in position being detectable using, for example a linear displacement sensor. Alternatively, tape may be passed around a roller which bears against a load cell. Tension in the tape affects the force applied to the load cell, such that the output of the load cell provides an indication of tape tension.

Indirect tension monitoring includes methods in which the power consumed by two motors is monitored, and a measure of tension is derived from that monitored power. Where the tape-drive includes two position-controlled motors such as stepper motors, monitoring the power supplied to the motors allows a measure of tape tension to be determined. This technique is described in further detail in our earlier UK Patent No. GB 2,369,602.

As noted above, tape drives in accordance with embodiments of the present invention may be used in thermal transfer printers of the type described above. Tape drives in accordance with embodiments of the present invention may be advantageously used in a thermal transfer over printer, such as may be used within the packaging industry, for instance for printing further information such as dates and bar codes over the top of pre-printed packaging (such as food bags).

Additionally, tape drives in accordance with embodiments of the present invention may be used in other applications, and provide similar advantages to those evident in thermal transfer printers, for instance fast and accurate tape acceleration, deceleration, speed and positional accuracy.

An alternative application where such tape drives may be applied is in labelling machines, which are adapted to apply labels detached from a continuous tape (alternatively referred to as a label web). Tape drives in accordance with embodiments of the present invention are suitable for use in labelling machines in which a label carrying web is mounted on a supply. Labels are removed from the web, and the web is driven onto a take-up spool.

In general, tape drives in accordance with embodiments of the present invention may be used in any application where there is a requirement to transport any form of tape, web or other continuous material from a first spool to a second spool.

Reference has been made in the foregoing description to DC motors. In the present context the term “DC motor” is to be interpreted broadly as including any form of motor that can be driven to provide an output torque, such as a brushless DC motor, a brushed DC motor, an induction motor or an AC motor. A brushless DC motor comprises any form of electronically commutated motor with integral commutation sensor. Similarly, the term stepper motor is to be interpreted broadly as including any form of motor that can be driven by drive signal indicating a required change of rotary position.

Further modifications and applications of the present invention will be readily apparent to the appropriately skilled person from the teaching herein, without departing from the scope of the appended claims.

What is claimed is:

1. A tape drive comprising two tape spool supports on which spools of tape may be mounted, at least one spool being drivable by a respective motor, a controller for controlling the energization of said at least one motor such that the tape may be transported in at least one direction between spools mounted on the spool supports, and a sensor configured to obtain signals indicative of electromagnetic radiation reflected from the tape, wherein means are provided to process two signals obtained by said sensor and to generate an output signal indicative of movement of said tape based on said signals.

2. A tape drive according to claim 1, wherein said means for processing two signals obtained by said sensor and generating said output signal comprises identification means for identifying portions of each of the two signals caused by electromagnetic radiation reflected from a common part of the tape and for generating said output signal based upon said portions of said two signals.

3. A tape drive comprising, two tape spool supports on which spools of tape may be mounted, at least one spool being drivable by a respective motor, a controller for controlling the energization of said at least one motor such that the tape may be transported in at least one direction between spools mounted on the spool supports, and a sensor configured to obtain signals indicative of electromagnetic radiation reflected from a moving tape drive element, wherein means are provided to process two signals obtained by said sensor and to generate an output signal indicative of movement of said tape drive element based on said signals, wherein said means for processing two signals obtained by said sensor and generating said output signal comprises identification means for identifying portions of each of the two signals caused by electromagnetic radiation reflected from a common part of the moving tape drive element and for generating said output signal based upon said portions of said two signals.

4. A tape drive according to claim 3, comprising two motors, wherein each spool is drivable by a respective one of said motors.

5. A tape drive according to claim 3, wherein the sensor is an optical sensor arranged to capture light reflected from the tape.

6. A tape drive according to claim 5, wherein the tape drive further comprises an illumination source arranged to illuminate at least a portion of the tape.

7. A tape drive according to claim 6, wherein the sensor comprises said illumination source.

8. A tape drive according to claim 5, wherein the sensor comprises a charge-coupled device to capture said reflected light.

9. A tape drive according to claim 3, wherein the sensor comprises said means to process said two signals, and is adapted to provide said output signal to said controller.

10. A tape drive according to claim 3, wherein the sensor is located proximate to a portion of the tape path between the spools.

11. A tape drive according to claim 3, wherein the controller is arranged to use the output signal to provide a control signal to drive at least one of said motors.

12. A tape drive according to claim 11, wherein the controller is operative to use the output signal to provide control signals to both of said motors.

13. A tape drive according to claim 3, wherein at least one of said motors is a torque-controlled motor.

14. A tape drive according to claim 13, wherein the controller is adapted to provide a control signal to the torque-controlled motor based upon said output signal such that the output angular position of the torque-controlled motor is controlled

15. A tape drive according to claim 3, wherein at least one of said motors is a position-controlled motor.

16. A tape drive according to claim 15, wherein said position-controlled motor is an open loop position-controlled motor.

17. A tape drive according to claim 3, wherein the controller is arranged to control the motors to transport tape in both directions between the spools.

18. A tape drive according to claim 17, wherein the controller is operative to monitor tension in a tape being transported between the spools.

19. A tape drive according to claim 3, wherein the controller is operative to control the motors to maintain tape tension within predetermined limits.

20. A tape drive according to claim 3, wherein the moving tape drive element comprises a rotating tape drive element, the position signal being indicative of rotational movement of the rotating tape drive element.

21. A tape drive according to claim 20, wherein the rotating tape drive element comprises a rotating disc arranged such that such that rotation of the disc is indicative of rotation of one of said spools of tape.

22. A tape drive according to claim 21, wherein said rotating disc is coupled to said spool.

23. A tape drive according to claim 19, wherein the position signal is indicative of a change of angular position of the rotating tape drive element.

24. A tape drive according to claim 3, wherein each spool support drivable by a respective motor is coupled to the respective motor by means of a drive coupling providing at least one fixed transmission ratio.

25. A tape drive according to claim 24, wherein the drive coupling comprises a drive belt.

26. A tape drive according to claim 1, wherein each spool support drivable by a respective motor has a respective first axis of rotation, the or each motor has a shaft with a respective second axis of rotation, and the respective first and second axes are co axial.

27. A tape drive according to claim 24, wherein each spool support has a respective spool shaft, each motor has a respective motor shaft and respective drive couplings interconnect a respective spool shaft to a respective motor shaft.

28. A tape drive according to claim 3 incorporated in a thermal transfer printer.

29. A tape drive according to claim 28, wherein the printer is configured to transfer ink from a printer ribbon to a substrate which is transported along a predetermined path adjacent to the printer, the tape drive acting as a printer ribbon drive mechanism for transporting ribbon between first and second ribbon spools, and the printer further comprising a printhead arranged to contact one side of the ribbon to press an opposite side of the ribbon into contact with a substrate on the predetermined path.

30. A tape drive according to claim 29, wherein the printer further comprises a printhead drive mechanism for transporting the printhead along a track extending generally parallel to the predetermined substrate transport path and for displacing the printhead into and out of contact with the ribbon, and a printer controller controlling the printer ribbon and printhead drive mechanisms.

31. A tape drive according to claim 30, wherein the printer controller is selectively programmable either to cause the ribbon to be transported relative to the predetermined substrate transport path with the printhead stationary and displaced into contact with the ribbon during printing, or to cause the printhead to be transported relative to the ribbon and the predetermined substrate transport path and to be displaced into contact with the ribbon during printing.

32. A tape drive according to claim 28, wherein the printer is a thermal transfer over printer.

33. A method for controlling a tape drive comprising two motors, two tape spool supports on which spools of tape may be mounted, each spool being drivable by a respective one of said motors, a controller for controlling the energization of at least one of said motors such that the tape may be transported in at least one direction between spools mounted on the spool supports, and a sensor configured to obtain signals indicative of electromagnetic radiation reflected from tape, wherein the method comprises processing two signals obtained by said sensor and to generate an output signal indicative of movement of said tape based on said signals.
